(19) United States
(12) Patent Application Publication
(10) Pub. No.: US 2010/0101584 A1
(43) Pub. Date: Apr. 29, 2010

(54) REUSABLE POROUS FILTRATION MASK WITH CONCEALED RESPIRATORY FILTER AND EXHALATION VALVES

(76) Inventors: Hannah Bledstein, Chicago, IL (US); Adrien Bledstein, Chicago, IL (US)

Correspondence Address: Harold J. Fassnacht;Clausen Miller PC, Suite 1600, 10 S. LaSalle Street, Chicago, IL, 60603-1098, US

(21) Appl. No.: 12/260,473

(22) Filed: Oct. 29, 2008

(51) Int. Cl. A62B 18/02

(52) U.S. Cl. 128/863

(57) ABSTRACT

A reusable, porous mask with a concealed respiratory filter and exhalation valves is provided. The mask comprises a flexible porous outer frame, a detachable semi-rigid respiratory filter that nests within the outer frame, and one or more exhalation valves attached to the respiratory filter so they are concealed behind the outer frame. The mask is flexible enough to be folded to fit inside a pocket or purse. The mask has the capability of enhancing the lives of people with respiratory disorders, people who wish to minimize their exposure to chemicals, particles and germs, and professionals who require respiratory protection.

### BACKGROUND

1. Field of the Invention

This patent relates to a filtration mask for reducing a wearer's exposure to indoor and outdoor pollutants. In particular, this patent relates to a filtration mask having an outer frame concealing a replaceable respiratory filter with exhalation valves for easier breathing and improved aesthetic appeal.

2. Description of the Related Art

For filtering indoor and outdoor pollutants, doctors recommend that patients wear filtration masks when exposed to particulate matter such as dust, pollen, dander, or mold, and substances such as ozone, smog, chemical fragrances and secondhand smoke. Generally, filtration masks fall into one of five categories:

Masks with Exhalation Valves

Exhalation valves make breathing through a filtration mask easier. Most exhalation valves include a thin valve or diaphragm that moves according to the user's breathing. When the user breathes in the diaphragm seats against a valve seat to close the exhalation valve, requiring ambient air to pass through the filtration part of the mask. When the user breaths out the diaphragm lifts from the valve seat allowing expelled air to pass through openings in the exhalation valve. Examples of masks with exhalation valves include those disclosed in U.S. Pat. Nos. 4,974,586 and 7,311,104, as well as the Techno™ mask available commercially from Respro (UK) Ltd.

### Scarf-Like Masks.

Scarf-like masks appeal to mask wearers who do not necessarily want to be seen wearing a mask, or at least prefer the appearance of wearing a face scarf to wearing a filtration mask. Examples of scarf-like masks include those sold commercially by Respro (UK) Ltd. under the brand names Bandit Scarf™ and Outlaw Biker Scarf™.

Masks with Improved Comfort and/or Fit

Many masks have been designed with improved comfort and/or fit. Masks in this general category include those having improved attachment means, masks that conform to a wearer's face, and masks having built in structural features to maintain an air space between the mask and the user's face. Examples of such masks include those described in U.S. Pat. Nos. 5,094,236; 6,474,336; 6,520,181; 6,644,314; 7,086,401 and 7,171,967, as well as the Greenscreen UNO™ mask sold commercially by MFI of Liberty, Ky.

Masks with Improved Filtering Properties

Numerous masks have been developed to have improved filtering properties. Among these masks are those described in U.S. Pat. Nos. 6,041,782 and 6,338,340.

### Miscellaneous Masks

The remaining category of masks consists of those that do not fit into the previous four categories, such as the mask disclosed in U.S. Pat. No. 7,044,127 (mask with drinking opening).

While all of these references describe masks having one or more distinctive features for improved breathability, improved aesthetics, better filtering, etc., and three references teach a mask having exhalation valves, none of the references known to the applicant teaches a mask in which the exhalation valves are attached to a respiratory filter that nests within and is concealed by an outer frame so that the exhalation valves are concealed from view.

Thus there remains a need for a mask having concealed exhalation valves for easier breathing and improved aesthetics.

Another object of the invention is to provide a mask that filters air pollutants, yet is comfortable to wear and has aesthetic appeal.

Another object of the invention is to provide a mask with a washable, resuable frame that holds and seals the filter.

Still another object of the invention is to provide a mask that has a hidden nose piece that can be contoured to the bridge of the nose to minimize fogging of glasses so people are more willing to wear the mask.

Another object of the invention is to provide a mask that is contoured away from the wearer's mouth for improved comfort and easier talking.

Yet another object of the invention is to provide a mask that can be conveniently folded or rolled to slip into a pocket or purse.

Another object of the invention is to provide a mask that is easy to put on and take off through the use of adjustable ear loops that fit most faces.

Further and additional objects will appear from the description, accompanying drawings, and appended claims.

### SUMMARY OF THE INVENTION

The present invention fulfills these objectives by providing a reusable mask comprising a porous outer frame that can be secured to a wearer's face and a detachable respiratory insert that nests within the outer frame. One or more exhalation valves can be disposed over openings in the respiratory filter so they are concealed behind the outer frame. The porous outer frame includes a hidden flexible nose piece that can be pinched against the user's nose and pressed under the eyes to seal the mask against the wearer's nose for an improved fit.

### THE DRAWINGS

FIG. 1 is a perspective view of a filtration mask according to the present invention as it might be worn by a user.

FIG. 2 is a cross-sectional view of the filtration mask of FIG. 1 taken across line 2-2, showing the hidden nose piece.

FIG. 3 is a perspective view of the filtration mask of FIG. 1 shown in partial cutaway to show the respiratory filter nested within the outer frame.

FIG. 4 is a cross-sectional view of the filtration mask of FIG. 3 taken across line 4-4, showing how the respiratory filter can be affixed to the outer frame.

FIG. 5 is another cross-sectional view of the filtration mask of FIG. 3 taken along line 5-5 to show the construction of an exhalation valve.

FIG. 6 is a perspective view of the respiratory filter of FIG. 3.

FIG. 7 is a perspective view of the filtration mask of the present invention, shown in partial cutaway view and with one of the exhalation valves shown in exploded view.

### DETAILED DESCRIPTION OF THE INVENTION

While this invention may be embodied in many forms, there is shown in the drawings and will herein be described in detail one or more embodiments with the understanding that this disclosure is to be considered an exemplification of the principles of the invention and is not intended to limit the invention to the illustrated embodiments.

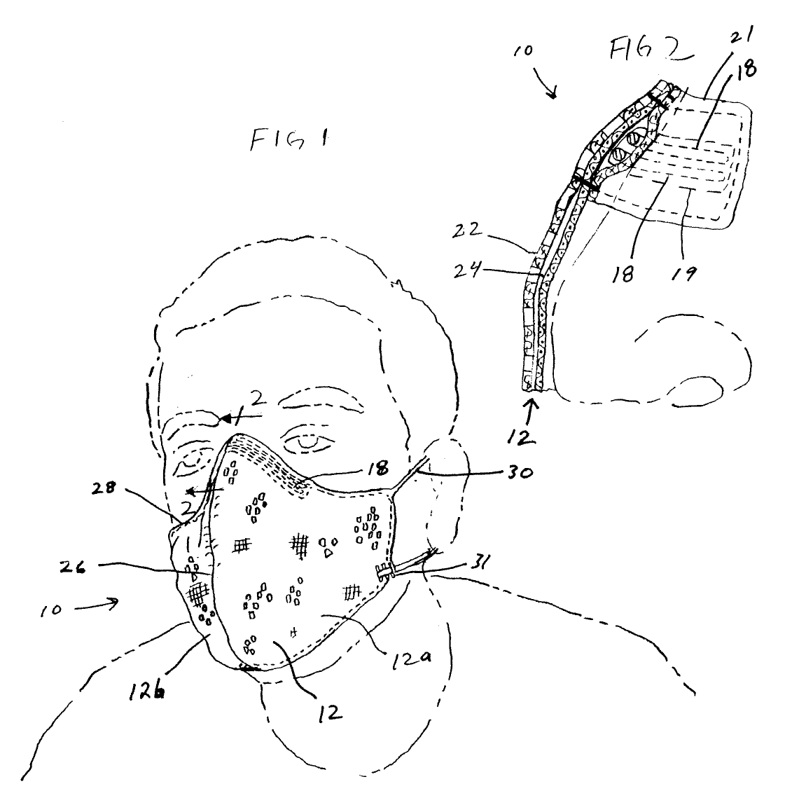

Turning to the drawings, there is shown in FIG. 1 one embodiment of the present invention, a reusable filtration mask with hidden exhalation valves. The mask 10 comprises a flexible porous outer frame 12 that can be secured over a user's mouth and nose, a detachable respiratory filter 14 made of a filtering material that fits inside the outer frame 12, one or more exhalation valves 16 disposed over openings in the respiratory filter 14 so they are hidden behind the outer frame 12, and an “invisible” flexible nose piece 18 attached to the outer frame 12 but also concealed from view by at least one layer of the outer frame 12.

The outer frame 12 preferably comprises two layers 22, 24 of relatively thin, lightweight, porous material. The outer layer 22, away from the wearer's face, should be made of a material that is aesthetically pleasing. The outer layer can be made of honeycomb mesh material, although any suitable porous material, such as lace, will suffice. The inner layer 24 is a net or mesh type material that provides additional structural support to the outer frame 12 and acts as a web to which the inner, respiratory filter 14 is attached.

The outer frame 12 is generally configured in two symmetrical halves or sides 12a, 12b; the two sides 12a, 12b being connected along a centrally located vertical fold or seam 26. A top edge 28 of the outer frame 12 is defined by both halves 12a, 12b and is configured to fit snugly against the wearer's face to prevent or minimize exhaled air from escaping between the top edge 28 and the wearer's face.

The flexible nose piece 18 can be a single wire-like member or, as shown in FIG. 2, a pair of wire-like members arranged in parallel and held within an encasement 19 made of plastic or other flexible material. The encasement 19 may be concealed within a sleeve 21 for comfort and invisibility and affixed to the outer frame 12 by stitching or other means. The nose piece 18 is attached to the outer frame 12 near the top edge 28 so that it straddles the centrally located vertical fold or seam 26, typically on the side of the mask facing the wearer. The nose piece 18 is malleable so that it can be shaped by the wearer to conform to the shape of the wearer's nose and extend under the eyes. The outer frame 12 includes adjustable ear loops 30 or other attachment means affixed to each side 12a, 12b for securing the mask 10 to the user's face. The ear loops may be attached to the outer frame 12 with buckles 31 as shown in the figures, double rings, eyehooks or other suitable means.

The respiratory filter 14 nests within the outer frame 12, and comprises an outer frame-facing filtering layer 32 and an inner liner 34 that contacts the wearer's face. The filtering layer 32 filters both indoor and outdoor pollutants, including fragrances, cigarette smoke, smog, diesel fumes, formaldehyde and household chemicals. The filtering layer 32 preferably contains activated carbon bound within a web of support material. Alternatively or in addition to the activated carbon web, the filtering layer 32 may contain antimicrobial agents to deactivate certain disease causing microbial species such as various bacteria, fungi and viruses.

The liner 34 preferably is made of supple fabric that filters particles such as dust and is comfortable when contacting the wearer's face. The liner 34 must be breathable, that is, air permeable, and may perform some supplementary filtering function.

Like the outer frame 12, the respiratory filter 14 is generally configured in two symmetrical halves or sides 14a, 14b connected along a centrally located vertical fold or seam 36. A top edge 38 of the respiratory filter 14 is substantially coextensive with the top edge of the outer frame 12. Hook and loop type patches 40, such as Velcro® brand patches, or other attachment means are affixed to each half of the respiratory filter 14 near its top edge 38 so that, when the respiratory filter 14 is placed inside the outer frame 12, the patches 40 cling to the inner layer 24 of the outer frame 12.

The semi-rigid nature of the respiratory filter 14 helps create an air space between the mask 10 and the wearer's face. The respiratory filter 14 may be used repeatedly and is disposable.

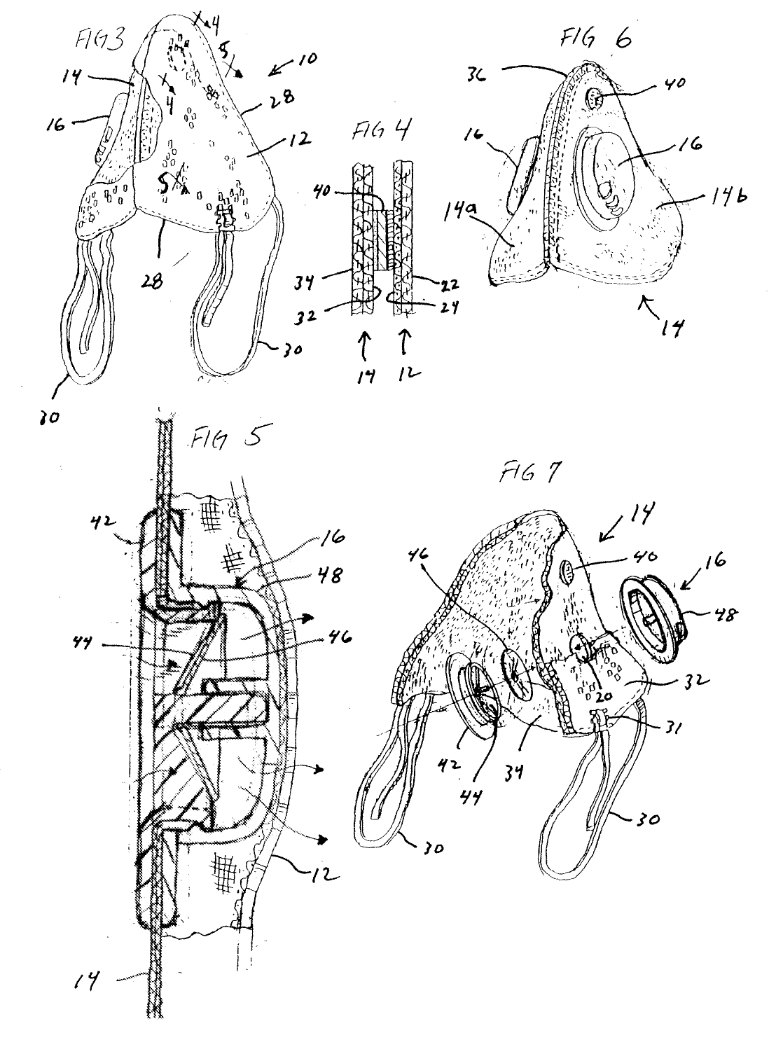

In an important aspect of the invention, exhalation valves 16 are disposed over openings 20 located on either side 14a, 14b of the respiratory filter 14, as shown in FIGS. 3 and 5-7. The exhalation valves 16 offer minimal resistance to outward breathing (exhalation), allowing the respiratory filter 14 to be thicker or more resistant to air flow than otherwise possible. The exhalation valves 16 are concealed behind the outer frame 12 when in use, resulting in a more aesthetically appealing mask 10. The exhalation valves 16 can be removed, washed and reused in a new disposable respiratory filter 14.

FIGS. 5 and 7 show a detailed construction of an exhalation valve 16. The valves are plastic and conventional in construction, and comprise a base 42 including an integrally formed valve seat 44, a flexible diaphragm or membrane 46, and a valve cover 48 with slots or other openings. The exhalation valve 16 has a closed and open position. In the closed position the flexible membrane 46 rests against (is seated on) the valve seat 44, which prevents air flow through the valve 16. In the open position, the flexible membrane 46 is lifted off the valve seat 44, allowing exhaled air to pass through the valve 16 in the direction of the arrows shown in FIG. 5.

The mask 10 is easy to put on and use. First the user places a respiratory filter 14 inside the outer frame 12 and presses the top of the respiratory filter 14 against the outer frame 12 to engage the Velcro® patches 40 to the outer frame 12. Ideally, the respiratory filter 14 is completely concealed behind the outer frame 12 when properly installed. Next, the user brings the mask up to his or her face and presses or pinches the nose piece 18 against his or her nose and under the eyes. The ear loops 30 are placed behind the user's ears and may be adjusted for length to provide a comfortable and effective fit.

Thus there has been described a reusable, porous filtration mask 10 with a concealed filtering layer 14 and exhalation valves 16. The mask 10 can be made in multiple sizes and is supple enough to be rolled to fit inside a pocket or purse. The mask 10 has an attractive, lean appearance and may be embellished for added attractiveness. The mask 10 has the capability of enhancing the lives of people with respiratory disorders, people who wish to minimize their exposure to germs, and professionals who require respiratory protection. The concealed exhalation valves 16 are particularly useful for wearers who engage in heavy exertion or work.

It is understood that the embodiments of the invention described above are only particular examples which serve to illustrate the principles of the invention. Modifications and alternative embodiments of the invention are contemplated which do not depart from the scope of the invention as defined by the foregoing teachings and appended claims. It is intended that the claims cover all such modifications and alternative embodiments that fall within their scope.

We claim as our invention:

1. A mask that covers the nose and mouth of a wearer, the mask comprising:
a flexible, porous outer frame comprising an outer layer and an inner layer, both layers being made from lightweight porous material, the outer frame having two symmetrical sides connected along a centrally located vertical seam and a top edge;
a nose piece attached to the outer frame along the top edge and concealed within the outer frame, the nose piece being malleable so that it can be shaped and reshaped to conform to the wearer's nose and seal under a wearer's eyes;
a semi-rigid respiratory filter comprising two halves of semi-rigid material connected by a central seam or fold and configured to nest within the outer frame and cover the mouth and nose of the wearer, the respiratory filter further comprising a filtering layer adjacent the outer frame and a liner made of supple, microbe resistant fabric;
means for detachably affixing the respiratory filter to the outer frame;
one or more exhalation valves removably affixed to openings in the respiratory filter so that, when the respiratory filter is nested within the outer frame, the exhalation valves are concealed behind the outer frame; and
means for securing the filtration mask to a user's face.

2. The mask of claim 1 wherein the exhalation valves comprise a base having an integrally formed valve seat, a flexible membrane and a slotted valve cover, the exhalation valves having a closed position and an open position, wherein in the closed position the flexible membrane is seated on the valve seat, and in the open position the flexible membrane is lifted off the valve seat.

3. The mask of claim 1 wherein the nose piece comprises a pair of wire-like members arranged in parallel and held within an encasement that is concealed within a sleeve.
